(19) United States
(12) Patent Application Publication
(10) Pub. No.: US 2025/0242511 A1
(43) Pub. Date: Jul. 31, 2025

(54) CUTTING AND CHOPPING TOOL FOR THE KITCHEN

(71) Applicant: Justin Scott, Kotzebue, AK (US)

(72) Inventor: Justin Scott, Kotzebue, AK (US)

(21) Appl. No.: 18/822,850

(22) Filed: Sep. 3, 2024

Related U.S. Application Data
(60) Provisional application No. 63/627,331, filed on Jan. 31, 2024.

(51) Int. Cl. B26D 3/18; B26D 7/00; B26D 7/26

(52) U.S. Cl. CPC B26D 3/185; B26D 7/2614; B26D 2007/0018; B26D 2210/02

(57) ABSTRACT

An apparatus for cutting and chopping vegetables, such as lettuce. The apparatus includes a body having a frame and legs. A grid blade unit is removably mounted to the frame and includes blades arranged in a grid for cutting the vegetables. A lid covers the grid blade unit and the frame, wherein the lid is pivotally mounted to the frame. The bottom surface of the lid has a grid of blocks that are arranged to correspond to the grid blade unit. The blocks are inserted into the respective cells of the grid blade unit when the lid is pressed over the frame. The movement of a block relative to the upper sharp edges of the blade while the block being inserted into the respective cell causes the slicing of a vegetable placed over the grid blade unit. The pieces of vegetables are collected in a pan.

### CROSS-REFERENCE TO RELATED APPLICATIONS

This application claims priority from a U.S. Provisional Patent Appl. No. 63/627,331, filed on Jan. 31, 2024, which is incorporated herein by reference in its entirety.

### FIELD OF INVENTION

The present invention relates to a chopping and cutting tool for the kitchen.

### BACKGROUND

In the realm of culinary convenience, prechopped lettuce from grocery stores has gained popularity among individuals seeking an easy and time-saving option for meal preparation. However, the allure of convenience comes with its own set of drawbacks, primarily concerning potential health hazards. Prechopped lettuce raises concerns about hygiene and freshness, as the pre-cut leaves are more susceptible to bacterial contamination due to increased exposure. Moreover, the cost of prechopped lettuce is higher compared to raw lettuce. Cutting fresh lettuce at home can be advantageous, however, it is time-consuming and laborious.

A need is therefore appreciated for an apparatus that allows chopping the lettuce safer and quicker.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for safely and quickly cutting vegetables at home.

It is another object of the present invention that the apparatus is portable and easy to use.

Still, another object of the present is that vegetables can be cut precisely.

Yet another object of the present invention is that the cutting and chopping process can be effortless.

An additional object of the present invention is that the apparatus has an ergonomic and user-friendly design.

Still, an additional object of the present invention is that the apparatus can store chopped vegetables.

In one aspect, disclosed is an apparatus for cutting and chopping vegetables, the apparatus includes a body that includes a frame. The apparatus further includes a grid blade unit supported by the frame and encased within the frame; and a lid having a proximal end and a distal end, wherein the proximal end of the lid is pivotally coupled to a side of the frame, wherein a bottom of the lid has a grid of blocks, wherein an arrangement of blocks in the grid of blocks corresponds to an arrangement of cells in the grid bade unit, wherein shapes of the blocks correspond to shapes of the cells so that each block can insert into the respective cell when the lid is closed over the frame.

In another aspect, the lid is pivotally coupled using a hinge joint. In another aspect, the apparatus further comprises a handle coupled to the distal end of the lid. In another aspect, the apparatus further comprises a container removably mounted to the body and below the frame. In another aspect, the top surface of the lid is flat. In another aspect, the blocks in the grid of blocks are arranged in a plurality of rows running parallel to each other. In another aspect, the cells and the blocks are cuboidal in shape. The grid blade unit is removably mounted to the frame permitting it to be cleaned or replaced. The body further comprises legs extending downwards from the frame, wherein the legs and the frame are integral.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a side view of an apparatus, according to an exemplary embodiment of the present invention.

FIG. 2 is a top view of the apparatus, according to an exemplary embodiment of the present invention.

FIG. 3 is a front view of the apparatus, according to an exemplary embodiment of the present invention.

FIG. 4 is a perspective view of the apparatus, according to an exemplary embodiment of the present invention.

FIG. 5 shows the apparatus in which the lid is lifted to show the blades, according to an exemplary embodiment of the present invention.

FIG. 6 shows another perspective view of the apparatus as in FIG. 5 further having a pan, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The described invention pertains to an apparatus for cutting and chopping vegetables, such as lettuce. The apparatus, also referred to herein as a tool, makes vegetable cutting and chopping easier, safer, and quicker.

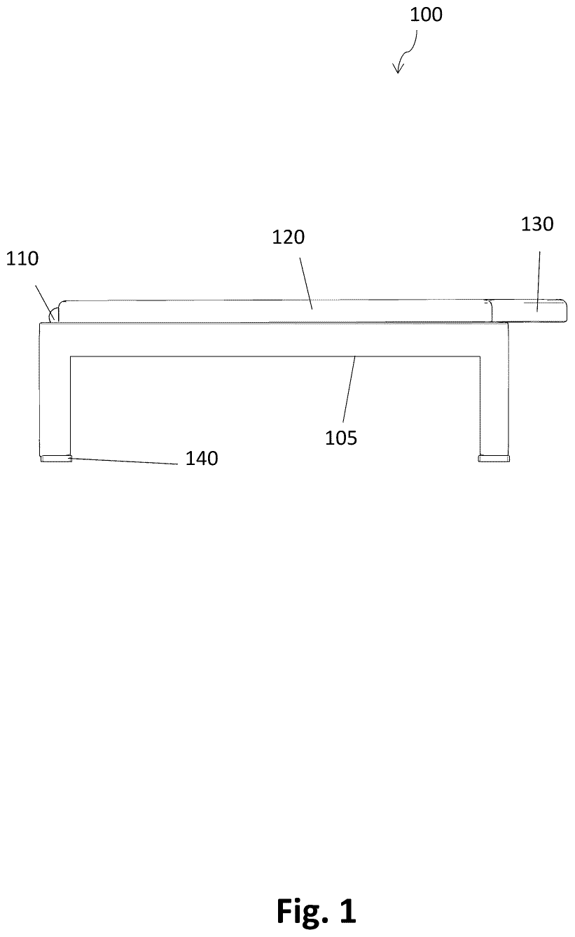

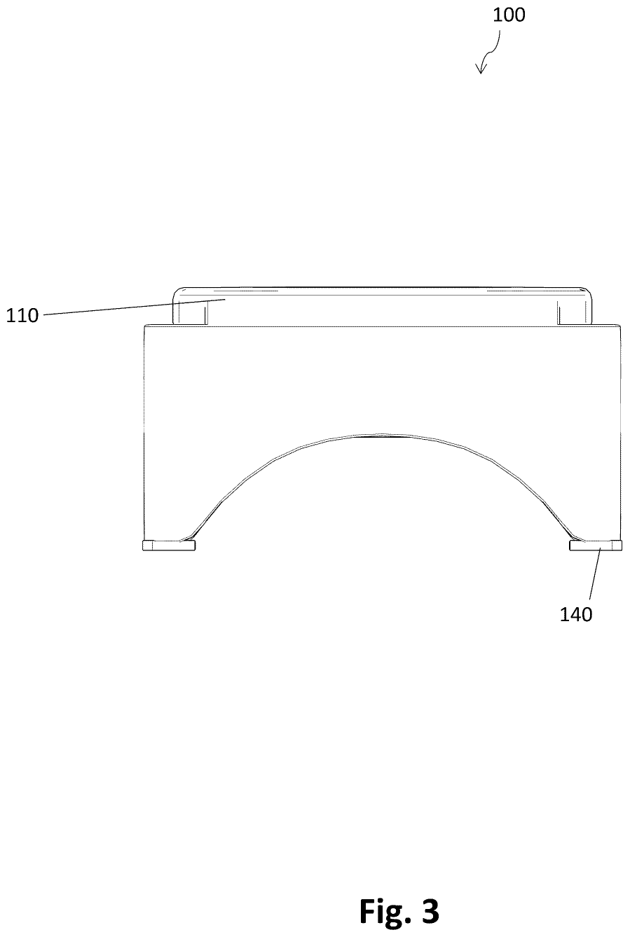

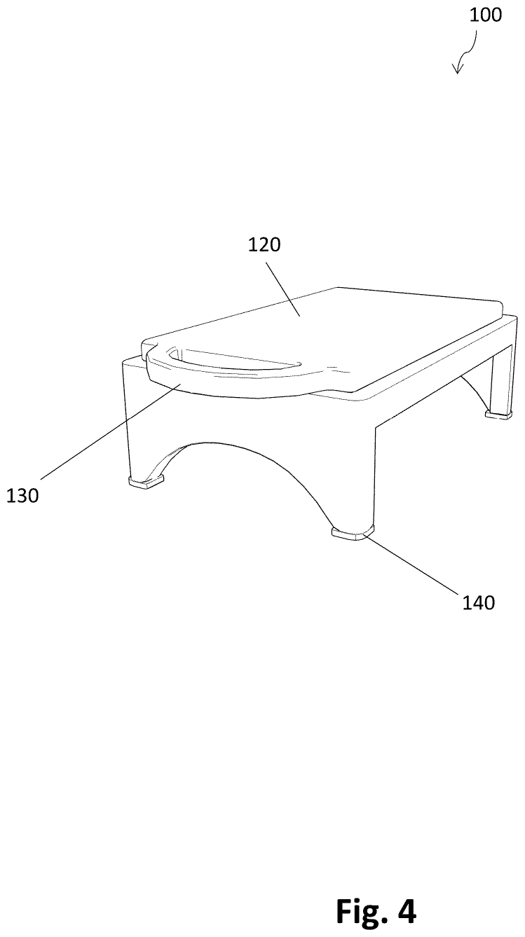

Referring to FIGS. 1-6 showing different views of the disclosed apparatus 100 for cutting and chopping vegetables. Apparatus 100 includes a body 105 that has a horizontal frame and a leg section supporting the frame to a specific height. The frame shown in the drawings is rectangular, however, the shape can be varied without departing from the scope of the present invention. For example, the frame of a square shape is within the scope of the present invention. Similarly, the corners of the rectangular or square-shaped frame can be rounded. Four legs can support the frame to a desired height.

In certain implementations, body 105 can be tubular i.e., made from tubes, wherein four tubes can make the frame and another four tubes can form the four legs, wherein the legs extend downwards from the corners of the frame. Body 105 can also be made from planks, for example, four planks of the required shape can be assembled to form the body. As shown in the drawing, the frame and the leg section can be integral. Alternatively, the leg section can be coupled to the frame. Also, the body can be manufactured as a single unit, for example, by molding. The body can be manufactured from any suitable material or combination of materials, such as wood, plastic, and metals. Preferably, the material can be weather-resistant and water-resistant. Also, the material can be food grade to prevent any contamination of the vegetable being cut using the apparatus.

The apparatus may also include pads 140 coupled to the bottom of the legs. The pads can grip on a surface over which the apparatus is placed. The pads may prevent slipping of the apparatus while cutting the vegetables. So, the pads can be made from any soft material such as rubber or silicone. Both rubber and silicone can provide good grip, slip resistance, and weather resistance. The use of pads may have another advantage of preventing scratching of the working surface by the legs.

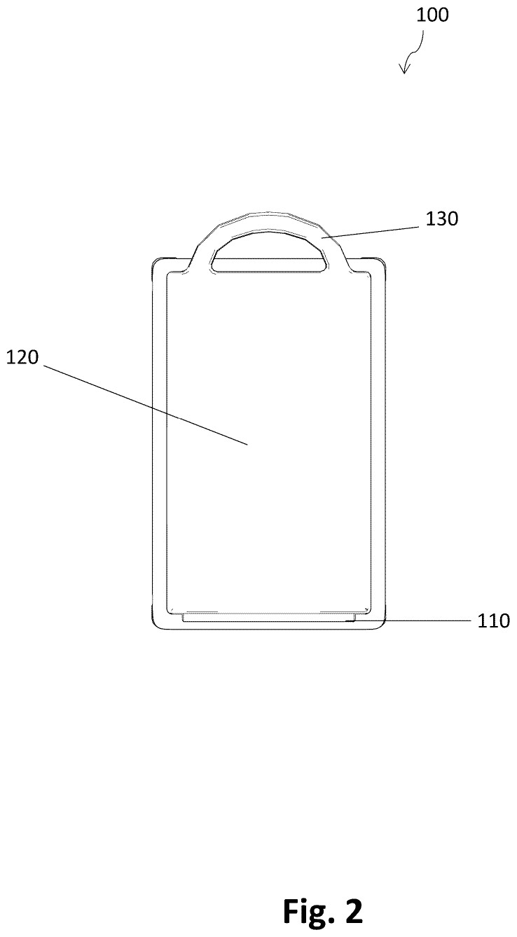

The apparatus 100 may also include a lid 120 covering the open top of the frame. The peripheral portion of the lid can lie over and supported by the frame when the lid is closed. The lid can have a proximal end and a distal end. The lid at its proximal end can be pivotally coupled to a side of the frame, as shown in the drawings. A hinge joint 110 can be used to pivotally couple the lid to the frame. The lid can pivot between the closed state and the open state. A handle 130 can be provided for lifting the lid from the closed state to the open state. The handle can be provided at the distal end of the lid. The handle can be of an ergonomic shape for being easily grasped by the hand of a user. For example, the hand shown in FIG. 2 is of a rounded shape with a gap in the center for the hand to pass through and grip the handle.

The handle can orient horizontally in a plane of the lid and extend away from the frame, as shown in FIG. 2. To cut the vegetables, some force has to be applied to the handle, and such a configuration of the handle, as shown in FIG. 2, can amplify the force applied. Thus, the user may have to apply less force for effortless cutting of the vegetables. However, any orientation of the handle is within the scope of the present invention. For example, the handle can be coupled perpendicularly to the top surface of the lid. The handle can also be made from any suitable material, such as wood, plastic, or metal. The handle and the lid can be made from the same or different materials. Moreover, the lid and the handle can be integrally formed as a single unit.

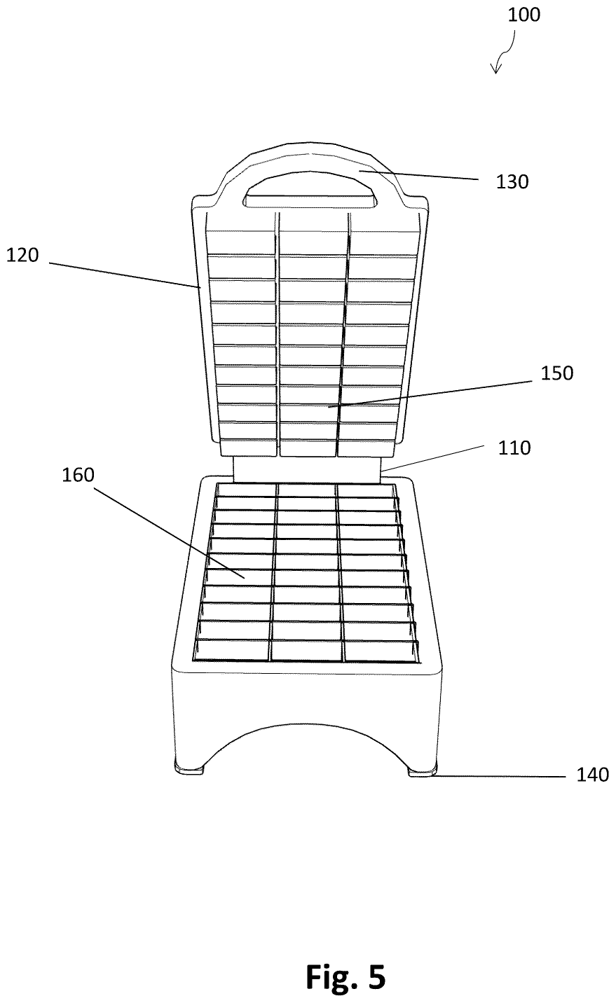

In certain implementations, the lid can have a top surface and a bottom surface. The top surface can be flat and used as a working surface. For example, the top surface can be used as a chopping board. The bottom surface of the lid can have blocks 150 arranged in a grid. FIG. 5 shows the blocks arranged in the rows and columns, wherein some spaces are between the adjacent blocks. FIG. 5 shows three parallel rows of blocks; however, the number of rows and the number of blocks in each row can be varied without departing from the scope of the present invention. Also, the shape and size of the blocks can be varied without departing from the scope of the present invention. Perhaps, the shape, size, and arrangement of the blocks may depend upon a blade unit described below.

The apparatus also includes a grid blade unit 160 that can be supported by the frame and encased within the frame. The grid blade unit can be in the form of a grid with multiple cells of blades. The upper edges of the grid blade unit can be sharp for cutting the vegetables. The shape of each cell of the grid blade unit can correspond to the shape of each block so that when the lid is closed, the blocks can be inserted into the respective cells of the grid blade unit. Each block of the lid can be inserted into the respective cell of the grid blade unit and there could be very little space between the upper edges of the blade and the walls of the block. The walls of the blocks may also contact the blades and hence no space between the blades and the walls of the blocks could be there.

In certain implementations, the blocks may not be cuboidal or cubes, but the walls of each block may slightly slant inwards from top to bottom. In such a case, the block can be inserted into the respective cell, and the upper edge of the blades can come in contact with the upper portion of the blocks.

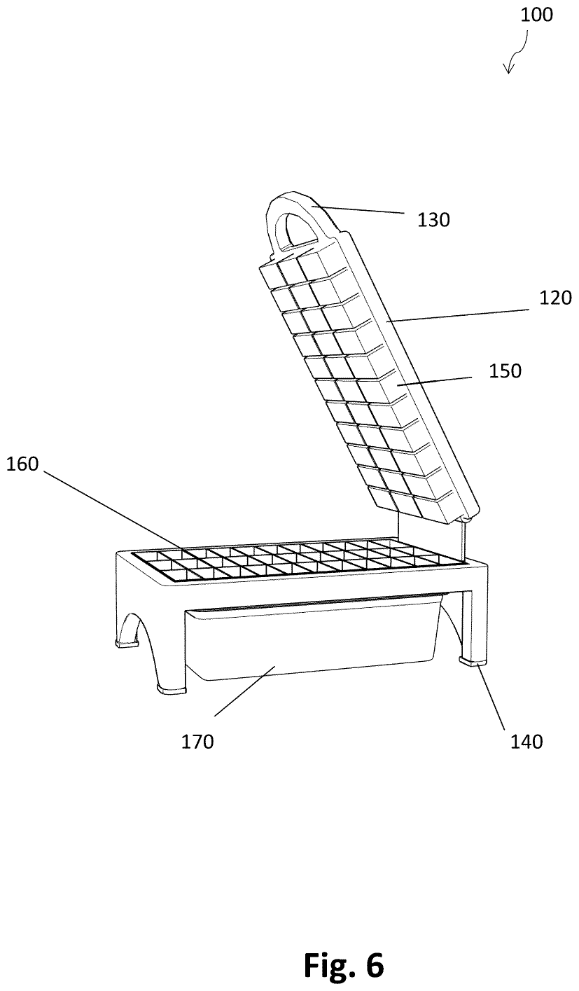

In use, vegetables to be cut or chopped can be placed over the grid blade unit. Once the vegetable is placed, the user can remove his or her hands from the frame. Thereafter, the user can grasp the handle and pivot the lid over the frame. The user may apply some force to push the blocks of the lid into the respective cells of the grid blade unit. The movement of the blocks relative to the blades causes slicing of the vegetable and pieces of the vegetable can fall below through the cells. The pieces of the vegetable can be collected at the bottom of the frame. FIG. 6 shows container 170, also referred to herein as a pan, is placed below the frame. The pieces of vegetables can be collected in the container.

In certain implementations, the container can be mounted to the bottom of the frame. The body can include suitable channels over which the container can slide. The container can be slid on the channels to position it below the frame for collecting the pieces of vegetables. Similarly, the container can slide out and the pieces of vegetables can be withdrawn from the container. A locking mechanism can also be provided to limit the movement of the container mounted to the body. This may prevent movement of the container while cutting the vegetables.

In summary, the apparatus is versatile in use and can be used for a range of vegetables including lettuce. The disclosed apparatus can accommodate various vegetables, enhancing its appeal for users looking for a multipurpose kitchen gadget. The apparatus streamlines the chopping process, saving users time and effort while ensuring a consistent and uniform cut for vegetables. An added benefit is the capacity of the apparatus to conveniently pile, and store freshly cut vegetables, reducing the need for additional containers.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for cutting and chopping vegetables, the apparatus comprises:
a body comprises a frame;
a grid blade unit supported by the frame and encased within the frame; and
a lid having a proximal end and a distal end, wherein the proximal end of the lid is pivotally coupled to a side of the frame, wherein a bottom of the lid has a grid of blocks, wherein an arrangement of blocks in the grid of blocks corresponds to an arrangement of cells in the grid bade unit, wherein shapes of the blocks correspond to shapes of the cells so that each block is capable for inserting into the respective cell when the lid is closed over the frame.

2. The apparatus of claim 1, wherein the lid is pivotally coupled using a hinge joint.

3. The apparatus of claim 1, wherein the apparatus further comprises a handle coupled to the distal end of the lid.

4. The apparatus of claim 3, wherein the apparatus further comprises a container removably mounted to the body and below the frame.

5. The apparatus of claim 4, wherein a top surface of the lid is flat.

6. The apparatus of claim 4, wherein the blocks in the grid of blocks are arranged in a plurality of rows running parallel to each other.

7. The apparatus of claim 6, wherein the cells and the blocks are cuboidal in shape.

8. The apparatus of claim 5, wherein the grid blade unit is removably mounted to the frame permitting it to be cleaned or replaced.

9. The apparatus of claim 1, wherein the body further comprises legs extending downwards from the frame, wherein the legs and the frame are integral.
